(19) United States
(12) Patent Application Publication
(10) Pub. No.: US 2006/0055829 A1
(43) Pub. Date: Mar. 16, 2006

(54) Gamma correction

(76) Inventor: Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/537,067

(22) PCT Filed: Nov. 6, 2003
(86) PCT No.: PCT/IB03/05067

§ 371 Date: Jun. 1, 2005

(30) Foreign Application Priority Data
Dec. 6, 2002 (EP) 02080104.9

(51) Int. Cl. H04N 9/69

(52) U.S. Cl. 348/675

(57) ABSTRACT

An image-processing unit (300) for transforming pixel values of a first video signal (Video1) into respective pixel values of a second video signal (Video2), on basis of the luminance-to-light transfer characteristic of a display device is disclosed. The image-processing unit (300) comprises: a band-split filter (302) for band-splitting the first video signal (Video1) into a first high-frequent signal (HF1) and a first low-frequent signal (LF1); a first pixel value transformation unit (304) for transforming the first high-frequent signal (HF1) into a second high-frequent signal (HF2) on basis of a first transfer function; a second pixel value transformation unit for transforming the first low-frequent signal (LF1) into a second low-frequent signal (LF2) on basis of a second transfer function which is different from the first transfer function; and a combining unit (308) for combining the second high-frequent signal (HF2) and the second low-frequent signal (LF2) into the second video signal (Video2).

The invention relates to a method of transforming pixel values of a first video signal into respective pixel values of a second video signal, on basis of the luminance-to-light transfer characteristic of a display device.

The invention further relates to an image-processing unit for transforming pixel values of a first video signal into respective pixel values of a second video signal, on basis of the luminance-to-light transfer characteristic of a display device.

The invention further relates to an image-processing apparatus comprising:
a receiving unit for receiving a first video signal; and
such an image-processing unit.

Recently, a large number of new display principles emerged from the search for television screens with properties the traditional Cathode Ray Tube (CRT) cannot meet. Particularly, Liquid Crystal Displays (LCD), Plasma Display Panels (PDP) and Organic Light Emitting Diodes (OLED) offer features as perfect geometry, small depth, and/or low power dissipation.

Apart from these favorable properties, the new displays devices come with a different luminance-to-light transfer, i.e. luminance-to-light characteristic. A CRT typically shows an exponential luminance-to-light characteristic, known as Gamma-curve. This luminance-to-light characteristic is usually approximated as:
I=Y^{2.8} (1)
where Y is the luminance signal, and I is the light output (illumination) from the screen. The new display devices have a luminance-to-light characteristic that may be anything from linear (PDP) to complex non-linear (S-curve for LCD). To compensate for these different luminance-to-light characteristics an image-processing unit can be part of the video path.

An unpleasant dilemma now occurs, caused by a property of all known display devices: they are spatially discrete in at least one dimension. The traditional CRT is spatially discrete in the vertical direction, a CRT with transposed scan is spatially discrete in the horizontal direction, and all matrix displays are spatially discrete in both horizontal and vertical direction. The discrete nature of a display makes that spatial patterns finer than the pitch of the discrete pixel structure cause alias, i.e. spectral components above the Nyquist frequency of the display device fold back and result in coarser but more visible patterns. Only frequencies up to the Nyquist frequency of the display device can be correctly represented.

In general, a non-linear operation causes harmonics. That means that in a non-linear transformation of luminance-to-light of the display device also harmonics are generated. If these generated harmonics are above the Nyquist frequency of the display device then these harmonics are fold back and cause disturbing low frequent patterns on the screen.

A strategy to prevent alias is to low-pass filter the video signal to a low-passed video signal such that high harmonics, which are generated by displaying the low-passed video signal by means of a display device with a non-linear luminance-to-light characteristic, are below the Nyquist frequency of the display device. The result of this low-pass filtering is a reduction of image detail.

It is an object of the invention to provide a method of the kind described in the opening paragraph for displaying a picture with a predetermined contrast distribution while preventing alias in highly detailed textures.

This object of the invention is achieved in that the method comprises:
band-splitting the first video signal into a first high-frequent signal and a first low-frequent signal;
transforming the first high-frequent signal into a second high-frequent signal on basis of a first transfer function;
transforming the first low-frequent signal into a second low-frequent signal on basis of a second transfer function which is different from the first transfer function; and
combining the second high-frequent signal and the second low-frequent signal into the second video signal.
   The first video signal is split into a first high- and a low-frequent signal, e.g. by using a so-called band-splitting filter. The first low-frequent signal substantially comprises spectral components below ½ or ⅓ of the Nyquist frequency of the display device and the first high-frequent signal substantially comprises spectral components above ½, ⅓ respectively of the Nyquist frequency of the display device. The Nyquist frequency of the display device is determined by the resolution of the display device. The processing, i.e. transforming of the first high-frequent signal into the second high-frequent signal is substantially determined by the requirement of alias prevention. The processing of the first low-frequent signal into the second low-frequent signal is hardly determined by the requirement of alias prevention. Instead of that, the processing of the first low-frequent signal into the second low-frequent signal might be determined by the requirement of showing a picture, which substantially corresponds with a scene being captured, i.e. the picture looks natural. Alternatively, the processing of the first low-frequent signal into the second low-frequent signal might be determined by the requirement of showing a picture with a relatively high contrast, which might be even higher than the contrast of an original image. Hence, an advantage is that multiple requirements can be met.

Preferably the first and second transfer function are implemented by means of respective Look-Up-Tables (LUT), which each comprise a mapping of input values to corresponding output values. The LUTs might comprise mappings from luminance values to luminance values or from Red, Green, Blue primary components (RGB) to Red, Green, Blue primary components.

In an embodiment of the method according to the invention the first transfer function is substantially equal to the inverse of the luminance-to-light transfer characteristic of the display device. In this case the succession (or combination) of the first transfer function and the luminance-to-light transfer of the display device, is substantially linear. An advantage of this embodiment according to the invention is that the generation of harmonics that would fold to disturbing low-frequent patterns in the output from the screen is prevented. This embodiment is particular of interest if there are hardly any pre-corrections in the video path from generation to display. That is e.g. the case when images are based on computer animations.

In another embodiment of the method according to the invention the first transfer function is substantially equal to the inverse of a combination of a pre-correction function in a video source from which the first video signal originates and the luminance-to-light transfer characteristic of the display device. In this case the succession, i.e. combination, of the pre-correction function (e.g. gamma correction of a camera), the first transfer function and the luminance-to-light transfer of the display device is substantially linear. This embodiment is particular of interest if there are pre-corrections in the video path from generating images to displaying images. That is e.g. the case when images are captured by means of a video camera and transmitted according to a television broadcast standard, e.g. CCIR Rec. 709. Pre-corrections are typically applied to match with the luminance-to-light characteristic of CRTs. A side effect of this type of pre-correction is an improved signal-to-noise ratio of the video path from capturing images to displaying images.

Next, the transfer of the low frequencies is discussed.

In an embodiment of the method according to the invention the second transfer function is based on the first video signal. This embodiment is particularly advantageous in cases where the wish exists to non-linearly re-scale the gray-levels in the image, e.g. for histogram equalization, black-stretch, or auto-pedestal, etcetera.

In another embodiment of the method according to the invention the second transfer function is substantially equal to the inverse of a pre-correction function in a video source from which the first video signal originates. In this case the succession of the pre-correction function (e.g. gamma correction of a camera) and the second transfer is substantially linear. This embodiment is particular of interest if there are pre-corrections in the video path from generation to display.

In another embodiment of the method according to the invention the second transfer function is based on a predetermined contrast enhancement as required by a viewer. Different viewers often have a different taste for contrast distribution. Some viewers prefer relatively much contrast in dark regions in the images, i.e. corresponding to low luminance values while other viewers prefer relatively much contrast in bright regions in the images, i.e. corresponding to high luminance values. Others prefer a contrast that is moderate for all regions of the images. The amount of ambient light is relatively important for the appearance of the images on the display device. Users might have different tastes for various ambient light conditions.

An embodiment of the method according to the invention comprises:
splitting the first video signal into a first horizontal high-frequent signal, a first vertical high-frequent signal and the first low-frequent signal;
transforming the first horizontal high-frequent signal into a second horizontal high-frequent signal on basis of the first transfer function;
transforming the first vertical high-frequent signal into a second vertical high-frequent signal on basis of a third transfer function which is different from the first transfer function; and
combining the second horizontal high-frequent signal, the second vertical high-frequent signal and the second low-frequent signal into the second video signal. Besides splitting the first video signal in high- and low-frequency components, the video signal is also split in vertical and horizontal components. Notice that a video signal represents two-dimensional images. That means e.g. that the mutual relation between pixels on rows of the images corresponds with a horizontal signal and that the mutual relation between pixels on columns of the images corresponds with a vertical signal. Splitting vertical from horizontal might succeed splitting high-frequent from low-frequent but alternatively splitting vertical from horizontal is preceding splitting high-frequent from low-frequent. The result is that three or four video signals are obtained. In general, on each of these video signals a separate transfer function is applied. Optionally, the transfer functions for two of the video signals are mutually equal. An advantage of this embodiment according to the invention is that an optimal transformation from luminance-to-light can be achieved if the vertical and horizontal resolutions of the display device are mutually different. In that case the horizontal and vertical Nyquist frequency of the display device are also mutually different.

It is a further object of the invention to provide an image-processing unit of the kind described in the opening paragraph for displaying a picture with a predetermined contrast distribution while preventing alias in highly detailed textures.

This object of the invention is achieved in that the image-processing unit comprises:
a band-split filter for band-splitting the first video signal into a first high-frequent signal and a first low-frequent signal;
a first pixel value transformation unit for transforming the first high-frequent signal into a second high-frequent signal on basis of a first transfer function;
a second pixel value transformation unit for transforming the first low-frequent signal into a second low-frequent signal on basis of a second transfer function which is different from the first transfer function; and
a combining unit for combining the second high-frequent signal and the second low-frequent signal into the second video signal.

It is a further object of the invention to provide an image-processing apparatus of the kind described in the opening paragraph for displaying a picture with a predetermined contrast distribution while preventing alias in highly detailed textures.

This object of the invention is achieved in that the image-processing unit of the image-processing apparatus, comprises:
a band-split filter for band-splitting the first video signal into a first high-frequent signal and a first low-frequent signal;
a first pixel value transformation unit for transforming the first high-frequent signal into a second high-frequent signal on basis of a first transfer function;
a second pixel value transformation unit for transforming the first low-frequent signal into a second low-frequent signal on basis of a second transfer function which is different from the first transfer function; and
a combining unit for combining the second high-frequent signal and the second low-frequent signal into the second video signal.
   Optionally the image-processing apparatus comprises the display device for displaying images on basis of the second video signal. Alternatively the image-processing apparatus does not comprise the optional display device but provides the second video signal to an apparatus that does comprise a display device.

Modifications of method and variations thereof may correspond to modifications and variations thereof of the image-processing unit and of the image-processing apparatus described.

These and other aspects of the method, of the image-processing unit and of the image-processing apparatus according to the invention will become apparent from and will be elucidated with respect to the implementations and embodiments described hereinafter and with reference to the accompanying drawings, wherein:

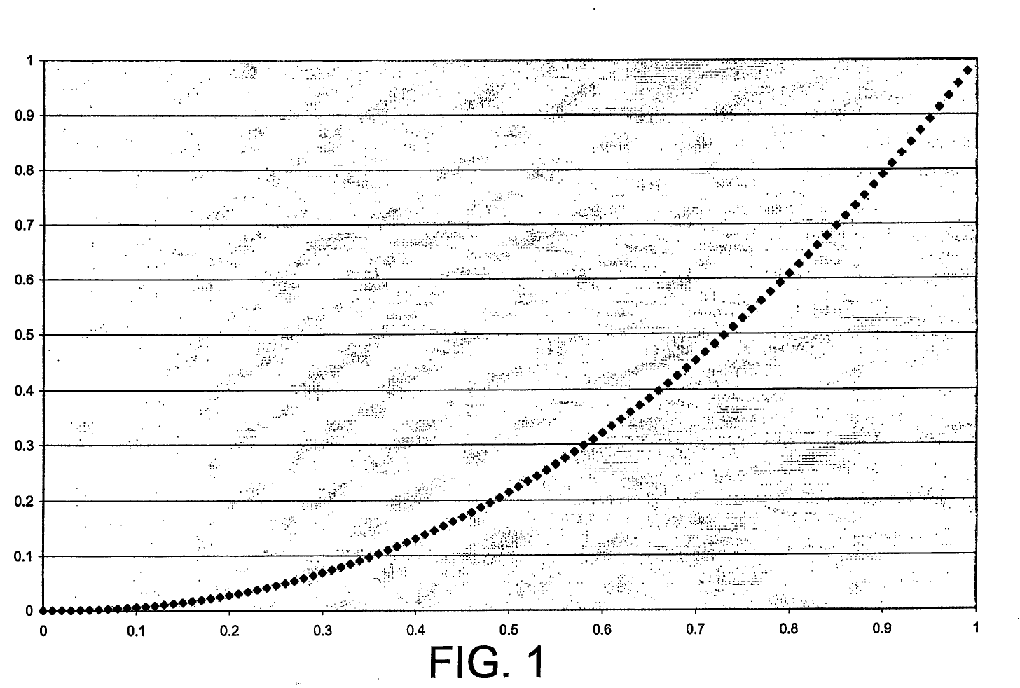

FIG. 1 schematically shows a luminance-to-light characteristic of a CRT;

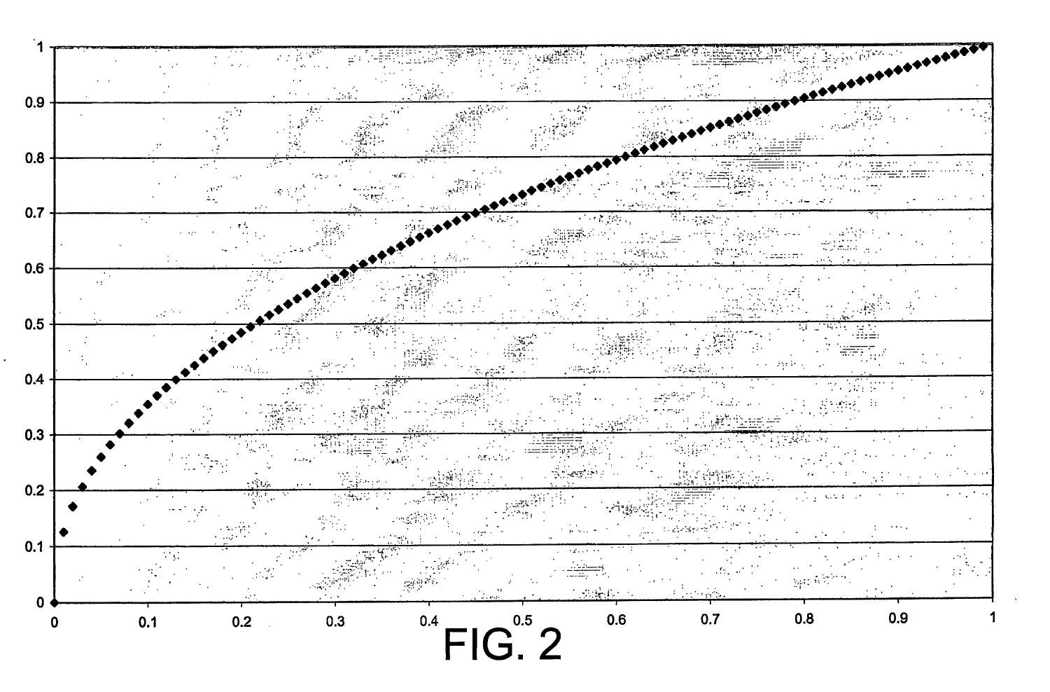

FIG. 2 schematically shows a gamma-correction function;

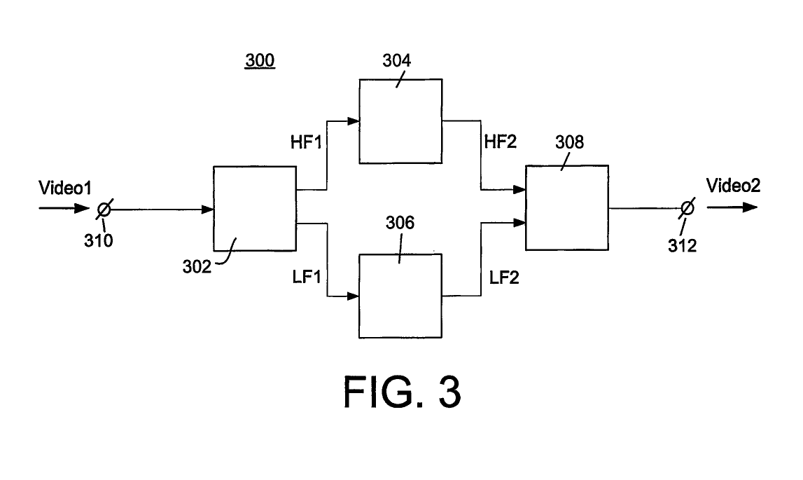

FIG. 3 schematically shows an embodiment of the image-processing unit;

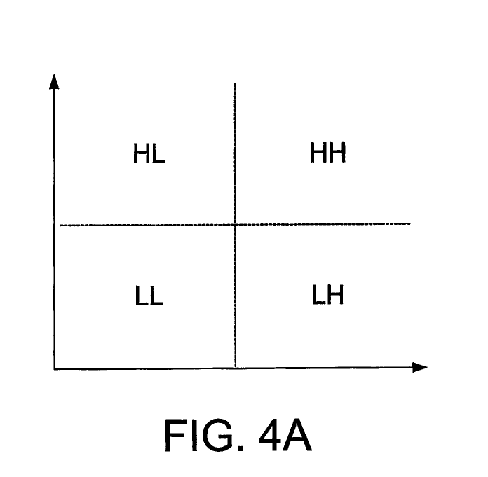

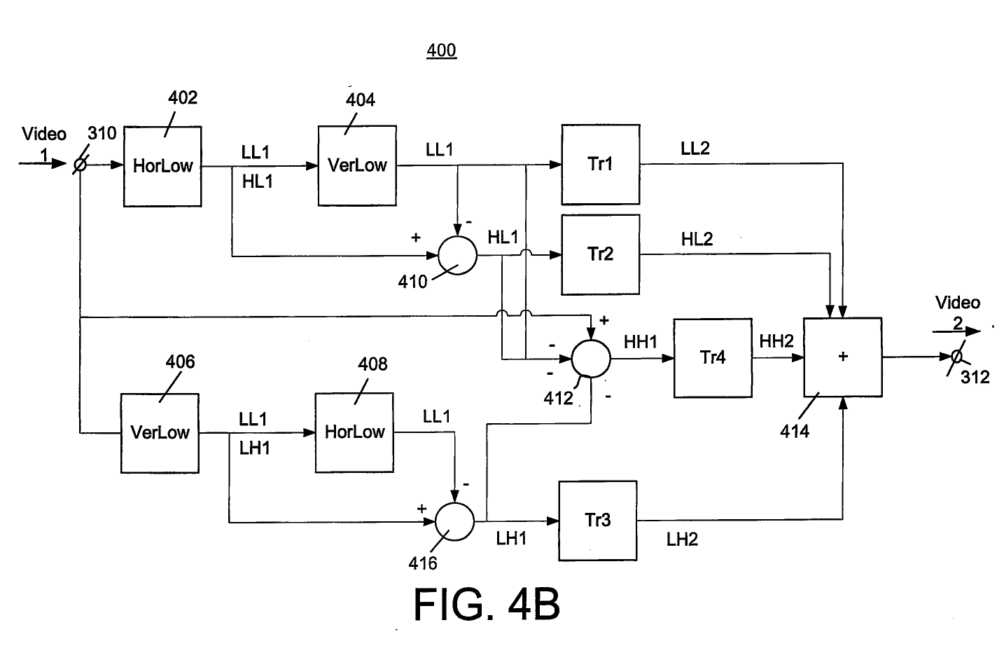

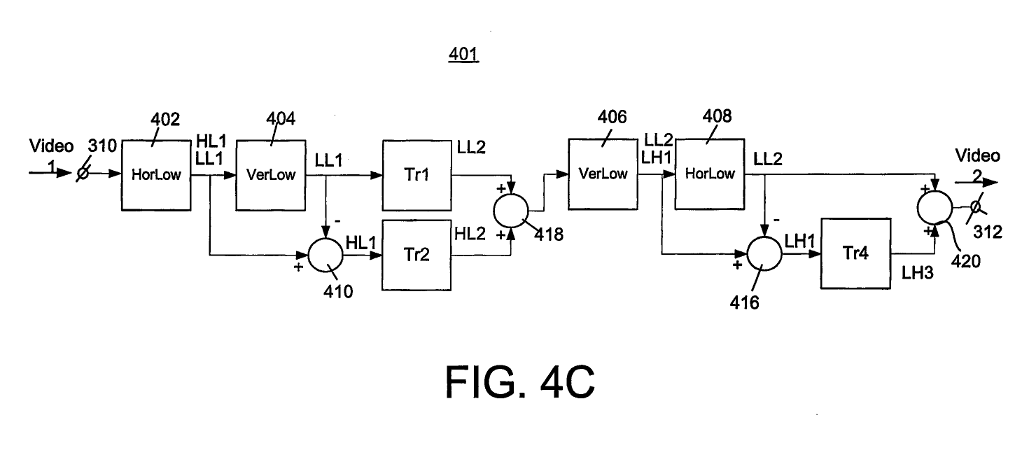

FIG. 4A schematically shows four parts in a two-dimensional frequency domain;

FIG. 4B schematically shows an embodiment of the image-processing unit, which is designed to process horizontal components and vertical components differently;

FIG. 4C schematically shows an alternative embodiment of the image-processing unit, which is designed to process horizontal components and vertical components differently;

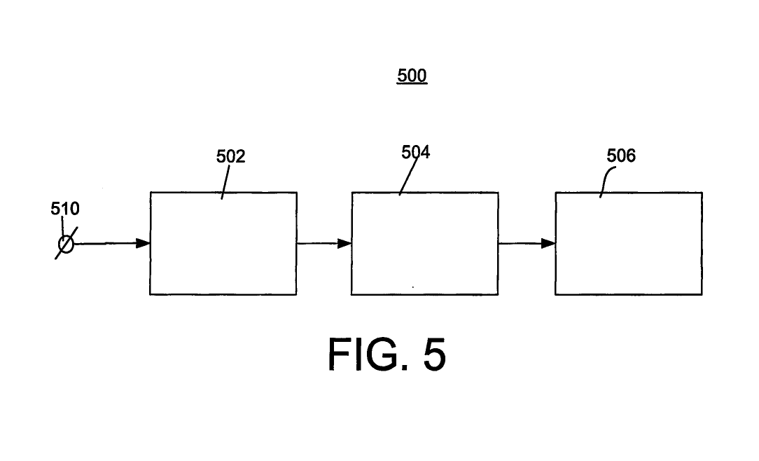

FIG. 5 schematically shows an embodiment of the image-processing apparatus; and

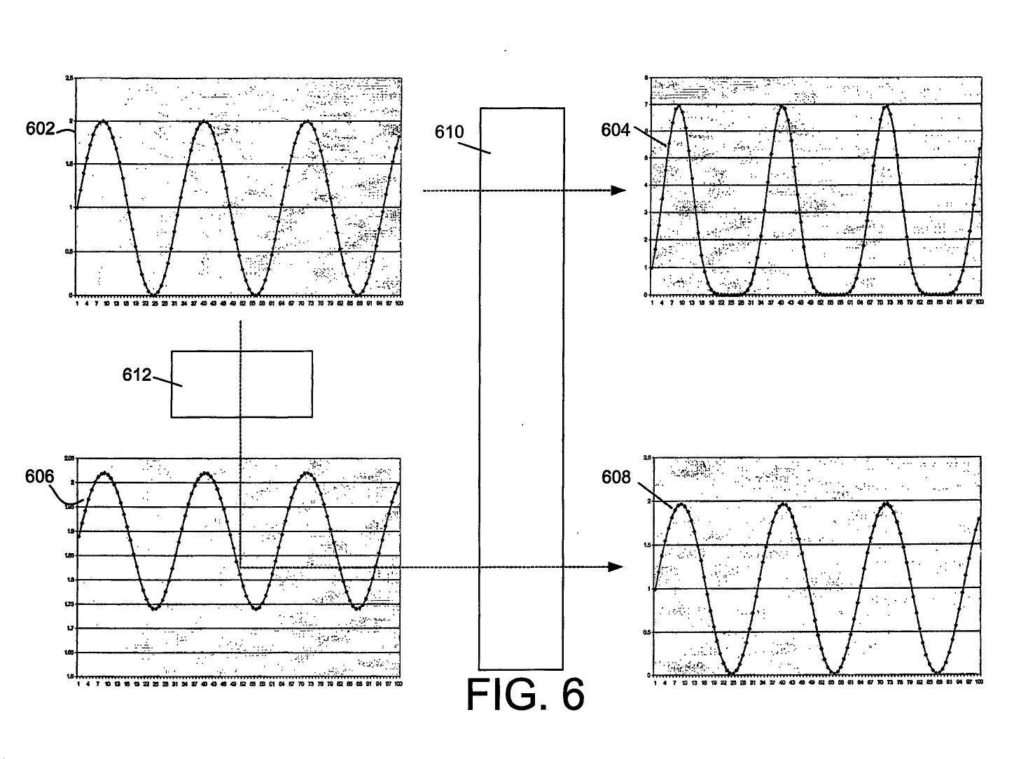

FIG. 6 schematically shows the effect of non-linear operations on a signal.

Same reference numerals are used to denote similar parts throughout the figures.

The intensity of light generated by a physical device is generally not a linear function of the applied signal. A conventional CRT has a power-law response to voltage: intensity produced at the face of the display is approximately the applied voltage, raised to the power 2.8. The numerical value of the exponent of this power function is colloquially known as gamma. This non-linearity must be compensated in order to achieve correct reproduction of intensity.

Human vision has a non-uniform perceptual response to intensity. If intensity is to be coded into a small number of steps, say 256, then in order for the most effective perceptual use to be made of the available codes, the codes must be assigned to intensities according to the properties of perception. In a typical eight-bit digital-to-analogue converter on a frame-buffer card, black is at code zero and white is at code 255.

FIG. 1 schematically shows a luminance-to-light characteristic of a CRT. The x-axis corresponds to normalized values of the video signal. Typically, the video signal as provided to a CRT has a voltage that ranges from zero to 700 mV. The y-axis corresponds to normalized values of the amount of illumination, i.e. the intensity of light. Typically, the amount of illumination as generated by a CRT ranges from 100 to 300 candelas per meter squared.

FIG. 2 schematically shows a gamma-correction function. In a video system, linear-light intensity is transformed to a non-linear video signal by gamma correction, which is universally done at the camera. This transformation is typically done in the electrical domain, i.e. an input signal is transformed into an output signal. The x-axis of FIG. 2 corresponds to normalized values of the input signal and the y-axis of the output signal.

FIG. 3 schematically shows an embodiment of the image-processing unit 300 according to the invention. The image-processing unit 300 is provided with a first video signal Video1 at the input connector 310 and the image-processing unit 300 provides a second video signal Video2 at the output connector 312, which is connected with a display device. The image-processing unit 300 is arranged to transform pixel values of the first video signal Video1 into respective pixel values of a second video signal Video2, on basis of the luminance-to-light transfer characteristic of the display device. The purpose of the image-processing unit 300 is to process the first video signal such that no disturbing alias artifacts appear on the display device, while the contrast of the pictures on the display device are tuned to the taste of a viewer.

The image-processing unit 300 comprises:
a band-split filter 302 for band-splitting the first video signal Video1 into a first high-frequent signal HF1 and a first low-frequent signal LF1;
a first pixel value transformation unit 304 for transforming the first high-frequent signal HF1 into a second high-frequent signal HF2 on basis of a first transfer function;
a second pixel value transformation unit 306 for transforming the first low-frequent signal LF1 into a second low-frequent signal LF2 on basis of a second transfer function, which is different from the first transfer function; and
a combining unit 308 for combining the second high-frequent signal HF2 and the second low-frequent signal LF2 into the second video signal Video2. This combining unit 308 might be an adder, which is arranged to add respective pixel values of the images being represented by the second high-frequent signal HF2 and the second low-frequent signal LF2. Preferably the first pixel value transformation unit 304 and the second pixel value transformation unit 306 are implemented by means of respective Look-Up-Tables. The entries of these LUTs correspond with the possible values of the first high-frequent signal HF1 and the first low-frequent signal LF1, respectively. The stored values of these LUTs correspond with the possible values of the second high-frequent signal HF2 and the second low-frequent signal LF2, respectively.

Below some examples are given of possible first and second transfer functions. These first and second transfer functions can be related to the type of the display device, or more particular the luminance-to-light transfer characteristic of the display device. Besides that the first and second transfer functions can be related to optional pre-correction in the video path from image creation to image display and can be related to preferences of the viewers regarding to contrast.

Assume that the display device to which the image-processing unit 300 is connected is a PDP with a linear luminance-to-light transfer characteristic and that the first video signal represents a television broadcast signal which is gamma corrected by the camera that captured the images. In this case the first transfer function corresponds with the inverse of the luminance-to-light transfer characteristic of the display device: a linear curve, and the second transfer function corresponds with the inverse of the gamma correction: a non-linear curve, i.e. a power function.

Assume that the display device to which the image-processing unit 300 is connected is a LCD with a non-linear, e.g. S-shaped, luminance-to-light transfer characteristic and that the first video signal represents a television broadcast signal which is gamma corrected by the camera that captured the images. In this case the first transfer function corresponds with the inverse of a combination of the gamma function and the luminance-to-light transfer characteristic of the display device: a non-linear curve. The second transfer function corresponds with the inverse of the gamma correction: a non-linear curve, i.e. a power function.

Assume that the display device to which the image-processing unit 300 is connected is a PDP with a linear luminance-to-light transfer characteristic and that the first video signal represents a computer generated signal to which no pre-corrections are applied. In this case the first transfer function corresponds with the inverse of the luminance-to-light transfer characteristic of the display device: a linear curve. The second transfer function corresponds with a contrast modification curve: a non-linear curve, e.g. a power function. The reason for this contrast modification curve might be a difference in expected and real ambient light conditions. Ambient lighting is rarely taken into account in the exchange of computer images. If an image is created in a dark environment and transmitted to a viewer in a bright environment, the recipient will find it to have excessive contrast. In this circumstance one could apply a power function with an exponent of about 1/1.1 or 1/1.2 to correct for the bright surround.

Assume that the display device to which the image-processing unit 300 is connected is an LCD with a non-linear, e.g. S-shaped, luminance-to-light transfer characteristic and that the first video signal represents a computer generated signal to which no pre-corrections are applied. In this case the first transfer function corresponds with the inverse of the luminance-to-light transfer characteristic of the display device: a non-linear curve (mirrored S-shape). The second transfer function might be a linear curve. Alternatively the second transfer function might be a non-linear contrast modification curve as described above.

Preferably the non-linear processing of the HF portion of the video signal should take place at the very last processing stage in front of the display, e.g. after image resizing (scaling), while more freedom exists for the position in the chain of the non-linear processing of the LF portion. Should there be the need to convert the digital signal to an analogue version (DA-conversion) than it is preferred that no post-filter is applied after the DAC, as this would eliminate the harmonics generated in the HF-path to compensate for the non-linear luminance-to-light transfer characteristic of the display device.

The band-split filter 302, the first pixel value transformation unit 304, the second pixel value transformation unit 306 and the combining unit 308 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

It should be noted that the order of processing steps might differ from what is described above. Optionally the incoming video signal is first transformed with a first predetermined transformation function, then filtered and subsequently transformed with a second predetermined transformation function. By doing this also a frequency dependent modification of the video signal can be achieved to compensate for a luminance-to-light characteristic of the display device which causes alias in the light domain.

The problems for which the invention gives a solution do also occur in case the video signal has been pre-corrected for application of a CRT (gamma-correction) while the applied display device is also of the CRT-type. The gamma pre-correction is usually implemented in the analogue signal path of the camera prior to digitization. Due to the anti-alias filter in front of the AD-converter, only the horizontally low frequencies, although maybe vertically high-frequent are corrected. The harmonics for the higher horizontal frequencies do not pass the anti-alias filter. With a conventionally, i.e. horizontally, scanned CRT, the display is only discrete in the vertical domain there is no problem, since high vertical frequencies are pre-corrected. However, if the CRT is discrete in the horizontal domain, which occurs for instance if the used CRT has a transposed scanning, than alias will occur because of the missing harmonics. Clearly, for matrix displays the problem exists both horizontally and vertically, and the mis-match with the pre-correction is likely to be different in the vertical and the horizontal domain.

FIG. 4A schematically shows four parts in a two-dimensional frequency domain. The x-axis corresponds with the frequency in the horizontal direction and the y-axis corresponds with the frequency in the vertical direction. The following four portions can be distinguished:
LL: components in this part of the two-dimensional frequency domain have a relatively low frequency in the horizontal direction and a relatively low frequency in the vertical direction;

LH: components in this part of the two-dimensional frequency domain have a relatively high frequency in the horizontal direction and a relatively low frequency in the vertical direction;
HL: components in this part of the two-dimensional frequency domain have a relatively low frequency in the horizontal direction and a relatively high frequency in the vertical direction; and
HH: components in this part of the two-dimensional frequency domain have a relatively high frequency in the horizontal direction and a relatively high frequency in the vertical direction.
   In the FIGS. 4B and 4C use is made of the definitions as provide above.

FIG. 4B schematically shows an embodiment of the image-processing unit 400, which is designed to process horizontal components and vertical components differently. The image-processing unit 400 is provided with a first video signal Video1 at the input connector 310 and the image-processing unit 400 provides a second video signal Video2 at the output connector 312, which is connected with a display device. The image-processing unit 400 is arranged to transform pixel values of the first video signal Video1 into respective pixel values of a second video signal Video2, on basis of the luminance-to-light transfer characteristic of the display device. The purpose of the image-processing unit 400 is to process the first video signal such that no disturbing alias artifacts appear on the display device, while the contrast of the pictures on the display device are tuned to the taste of a viewer. The working of the image-processing unit 400 is a follows.

The first video signal Video1 is filtered by means of a horizontal low-pass filter 402 resulting in a signal comprising LL1 and HL1 components. This signal is filtered by means of a vertical low-pass filter 404 resulting in a signal which only comprises LL1 components. By subtracting the signal which only comprises LL1 components from the signal comprising LL1 and HL1 components a signal comprising HL1 components is achieved. This subtraction is performed by means of subtraction unit 410.

The first video signal Video1 is also filtered by means of a vertical low-pass filter 406 resulting in a signal comprising components LL1 and LH1. This signal is filtered by means of a horizontal low-pass filter 408 resulting in a signal which only comprises LL1 components. By subtracting the signal which only comprises LL1 components from the signal comprising LL1 and LH1 components a signal comprising LH1 components is achieved. This subtraction is performed by means of subtraction unit 416.

By subtracting a signal comprising LL1 components, signal comprising HL1 components and a signal comprising LH1 components from the first video signal Video1 a signal comprising HH1 components is achieved. This subtraction is performed by means of subtraction unit 412.

The signal comprising LL1 components is transformed by means of pixel value transformation unit Tr1 into a signal comprising LL2 components. The signal comprising HL1 components is transformed by means of pixel value transformation unit Tr2 into a signal comprising HL2 components. The signal comprising LH1 components is transformed by means of pixel value transformation unit Tr3 into a signal comprising LH2 components. The signal comprising HH1 components is transformed by means of pixel value transformation unit Tr4 into a signal comprising HH2 components.

By means of the combining unit 414 the signal comprising LL2 components, the signal comprising HL2 components, the signal comprising LH2 components and the signal comprising HH2 components are combined to the second video signal Video2.

Optionally some of the transfer functions are mutually equal.

FIG. 4C schematically shows an alternative embodiment of the image-processing unit, which is designed to process horizontal components and vertical components differently. The image-processing unit 401 is provided with a first video signal Video1 at the input connector 310 and the image-processing unit 401 provides a second video signal Video2 at the output connector 312, which is connected with a display device. The image-processing unit 401 is arranged to transform pixel values of the first video signal Video1 into respective pixel values of a second video signal Video2, on basis of the luminance-to-light transfer characteristic of the display device. The purpose of the image-processing unit 401 is to process the first video signal such that no disturbing alias artifacts appear on the display device, while the contrast of the pictures on the display device are tuned to the taste of a viewer. The working of the image-processing unit 401 is a follows.

The first video signal Video1 is filtered by means of a horizontal low-pass filter 402 resulting in a signal comprising LL1 and HL1 components. This signal is filtered by means of a vertical low-pass filter 404 resulting in a signal which only comprises LL1 components. By subtracting the signal which only comprises LL1 components from the signal comprising LL1 and HL1 components a signal comprising HL1 components is achieved. This subtraction is performed by means of subtraction unit 410.

The signal comprising LL1 components is transformed by means of pixel value transformation unit Tr1 into a signal comprising LL2 components. The signal comprising HL1 components is transformed by means of pixel value transformation unit Tr2 into a signal comprising HL2 components.

By means of the combining unit 418 the signal comprising LL2 components and the signal comprising HL2 components are combined to a signal which is provided to a vertical low-pass filter 406. The output of this vertical low-pass filter 406 is a signal comprising LL2 and LH1 components. This signal is filtered by means of a horizontal low-pass filter 408 resulting in a signal which only comprises LL2 components. By subtracting the signal which only comprises LL2 components from the signal comprising LL2 and LH1 components a signal comprising LH1 components is achieved. This subtraction is performed by means of subtraction unit 416. The signal comprising LH1 components is transformed by means of pixel value transformation unit Tr4 into a signal comprising LH3 components.

By means of the combining unit 420 the signal comprising LL2 components and the signal comprising LH3 components are combined to the second video signal Video2.

Optionally some of the transfer functions are mutually equal.

FIG. 5 schematically shows an embodiment of the image-processing apparatus 500 according to the invention, comprising:
Receiving means 502 for receiving a signal representing input images. The signal may be a broadcast signal received via an antenna or cable but may also be a signal from a storage device like a VCR (Video Cassette Recorder) or Digital Versatile Disk (DVD). The signal is provided at the input connector 510;
The image-processing unit 504 as described in connection with FIG. 3 or FIG. 4; and
A display device 506 for displaying the output images of the image-processing unit 504.
   The image-processing apparatus 500 might e.g. be a TV. Alternatively the image-processing apparatus 500 does not comprise the optional display device 506 but provides the output images to an apparatus that does comprise a display device 506. Then the image-processing apparatus 500 might be e.g. a set top box, a satellite-tuner, a VCR player, a DVD player or recorder. Optionally the image-processing apparatus 500 comprises storage means, like a hard-disk or means for storage on removable media, e.g. optical disks. The image-processing apparatus 500 might also be a system being applied by a film-studio or broadcaster. The image-processing apparatus 500 might also be a computer, e.g. PC. The video processing as described in connection with the Figs. might be performed by means of the computer, but alternatively the processing is included in the display device, i.e. the monitor.

FIG. 6 schematically shows the effect of non-linear operations on a signal. FIG. 6 schematically illustrates the invention. Suppose there is a display device which has a non-linear luminance-to-light transfer characteristic. Further, suppose there is a first video signal 602 which comprises one frequency component with frequency fᵢₙ, which is just below the Nyquist frequency of the display device: f_{Nyquist}−fᵢₙ=ε, with ε relatively small. If this first video signal 602 is provided to the display device then aliasing is visible on the display device. This can be understood when the converted signal 604 is inspected. This converted signal 604 is derived from the first video signal 602 by means of transforming the first video signal 602 with a transfer function, which resembles the non-linear luminance-to-light transfer characteristic of the display device. This converted signal 604 comprises frequency components, which are above the frequency fᵢₙ of the frequency component of the first video signal 602, since the slopes of the curve are steeper than the slopes of the sinus of the first video signal 602.

To compensate for the alias, which occurs if the first video signal 602 is directly provided to the display device, now the first video signal is pre-compensated by means of a transfer function 612 resulting in the pre-compensated video signal 606. It should be noted that by this pre-compensation also high frequency components above the Nyquist frequency of the display device can be introduced. If this pre-compensated video signal 606 is provided to the display device with its non-linear luminance-to-light transfer characteristic then the final signal 608 is achieved which substantially corresponds with the first video signal 602. That means that there are hardly any frequency components, which result in alias.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. Method of transforming pixel values of a first video signal into respective pixel values of a second video signal, on basis of the luminance-to-light transfer characteristic of a display device, comprising:
band-splitting the first video signal into a first high-frequent signal and a first low-frequent signal;
transforming the first high-frequent signal into a second high-frequent signal on basis of a first transfer function;
transforming the first low-frequent signal into a second low-frequent signal on basis of a second transfer function which is different from the first transfer function; and
combining the second high-frequent signal and the second low-frequent signal into the second video signal.

2. A method as claimed in claim 1, characterized in that the first transfer function is substantially equal to the inverse of the luminance-to-light transfer characteristic of the display device.

3. A method as claimed in claim 1, characterized in that the first transfer function is substantially equal to the inverse of a combination of a pre-correction function in a video source from which the first video signal originates and the luminance-to-light transfer characteristic of the display device.

4. A method as claimed in claim 1, characterized in that the second transfer function is based on the first video signal.

5. A method as claimed in claim 2, characterized in that the second transfer function is substantially equal to the inverse of a pre-correction function in a video source from which the first video signal originates.

6. A method as claimed in claim 1, characterized in that the second transfer function is based on a predetermined contrast enhancement as required by a viewer.

7. A method as claimed in claim 1, characterized in comprising
splitting the first video signal into a first horizontal high-frequent signal, a first vertical high-frequent signal and the first low-frequent signal;
transforming the first horizontal high-frequent signal into a second horizontal high-frequent signal on basis of the first transfer function;
transforming the first vertical high-frequent signal into a second vertical high-frequent signal on basis of a third transfer function which is different from the first transfer function; and
combining the second horizontal high-frequent signal, the second vertical high-frequent signal and the second low-frequent signal into the second video signal.

8. An image-processing unit for transforming pixel values of a first video signal into respective pixel values of a second video signal, on basis of the luminance-to-light transfer characteristic of a display device, comprising:
a band-split filter for band-splitting the first video signal into a first high-frequent signal and a first low-frequent signal;
a first pixel value transformation unit for transforming the first high-frequent signal into a second high-frequent signal on basis of a first transfer function;
a second pixel value transformation unit for transforming the first low-frequent signal into a second low-frequent signal on basis of a second transfer function which is different from the first transfer function; and
a combining unit for combining the second high-frequent signal and the second low-frequent signal into the second video signal.

9. An image-processing apparatus comprising:
a receiving unit for receiving a first video signal; and
the image-processing unit as claimed in claim 7.

10. An image-processing apparatus as claimed in claim 8, characterized in comprising the display device for displaying images on basis of the second video signal.

11. A TV comprising the image-processing apparatus as claimed in claim 10.

12. An image-processing apparatus as claimed in claim 10, characterized in that the image-processing apparatus is a monitor to be connected to a computer.
